(19) United States
(12) Patent Application Publication
(10) Pub. No.: US 2024/0167690 A1
(43) Pub. Date: May 23, 2024

(54) DISPLAY SYSTEM AND OPERATION FOR AN INDUCTIVE COOKTOP

(71) Applicant: GHSP, Inc., Holland, MI (US)

(72) Inventors: Benjamin Moes, Caledonia, MI (US); Marc Smeyers, Zeeland, MI (US)

(21) Appl. No.: 18/058,068

(22) Filed: Nov. 22, 2022

(51) Int. Cl. F24C 7/08; G09G 3/3208; H05B 6/06; H05B 6/12

(52) U.S. Cl. CPC F24C 7/083; F24C 7/086; G09G 3/3208; H05B 6/062; H05B 6/1236; H05B 2213/06

(57) ABSTRACT

An inductive cooktop includes a transparent panel arranged to support a cookware object, and an electrically actuated display panel disposed below the transparent panel. The display panel includes a first set of lines and a second set of lines disposed orthogonally and forming a 2D matrix arranged to operate picture elements at intersections of the first and second sets of lines, where each picture element is refreshed at a refresh rate. An induction coil is below the display panel to generate a time varying electromagnetic field that inductively couples with the cookware object supported at the transparent panel. A driver is in electronic communication with the induction coil for providing power to the induction coil. The refresh rate is synchronized to the time varying electromagnetic field to minimize an induced voltage on one of the first and second set of lines of the display panel.

### TECHNICAL FIELD

The present disclosure relates generally to an inductive cooktop system with a display, and more specifically to reducing or eliminating induced voltage on clock lines causing incorrect pixel data in a display of an inductive cooktop system.

### BACKGROUND

Kitchens or other areas used to prepare and cook food may have an inductive cooktop, such as a cooktop that is part of a range unit or a separate cooktop unit that is placed on or installed directly in a countertop or other work surface. It is known that inductive cooktops can be used to effectively heat metal cookware that is capable of inductive coupling with a time varying electromagnetic (EM) field generated by the cook top.

It is common for inductive cooktops to have a top panel that supports cookware on the cooktop, such that during use, the top panel is often conductively heated by the inductively heated cookware. The residual heat at the top surface of the top panel is often dangerous to touch and is difficult and sometime unable to be visibly recognized. Presently known measures to indicate a hot top surface are provided by lights adjacent to the hot area or with messages displayed on a relatively small display screen at the front edge of the cooktop, which is frequently located away from the hot area of the top surface.

Attempts to incorporate displays or other electronics near to or overlapping the hot areas of the top panel can encounter several issues, such as those related to the heat's negative effect on the operation of the display electronics and issues related to the magnetic fields generated by the induction coils interfering with operation of the display and other electronics.

### SUMMARY

The present disclosure provides an inductive cooktop system and corresponding methods for an operating an inductive cooktop. An inductive cooktop has a transparent panel configured to support a cookware object. The inductive cooktop has an electrically actuated display panel disposed below the transparent panel. The electrically actuated display panel has a first set of lines and a second set of lines disposed orthogonal to each other to form a two dimensional matrix that is configured to operate pixels disposed at intersections of the first set and second set of lines. Each pixel of the display panel is repeatedly refreshed at a refresh rate. An induction coil is disposed below the electrically actuated display panel. The induction coil is operable to generate a time varying electromagnetic field that inductively couples with the cookware object supported at the transparent panel. The inductive cooktop includes a driver in electronic communication with the induction coil. The driver has a power source for providing power to the induction coil to generate the time varying electromagnetic field. The refresh rate is synchronized to the time varying electromagnetic field to minimize an induced voltage on one of the first and second set of lines.

In one or more implementations, the power source is an alternating current (AC) voltage source generating an AC waveform, and the refresh rate is synchronized to the time varying electromagnetic field to refresh at a zero-cross point of the AC waveform. In one or more implementations, the power source is a direct current (DC) power source generating a square waveform between a power-on and a power-off state, and the refresh rate is synchronized to refresh at a power-off state of the time varying electromagnetic field.

In one or more implementations, the time varying electromagnetic field operates at a frequency between ⅔ and ½ of a frequency of the refresh rate. In one or more implementations, the time varying electromagnetic field operates at a frequency equal to the refresh rate, and the panel refresh is synchronized to a zero-cross point of the time varying electromagnetic field generated by the induction coil.

In one or more implementations, the induction coil comprises a conductive wire wound around a ferrite core. The ferrite core defines a longitudinal axis of the induction coil. In one or more implementations, the longitudinal axis may be parallel to one of the first set of lines or the second set of lines of the display panel. In one or more implementations, the longitudinal axis is angled with respect to one of the first set of line or the second set of lines of the display panel between 1° to 45°. In one or more implementations, the induction coil, the conductive wire is wound around the horizontal central portion of the ferrite core between the vertical members.

In one or more implementations, the ferrite core has a first end vertical ferrite member, a second end vertical ferrite member opposite the first end along the central portion, and a third central vertical ferrite member between the first and second end vertical ferrite members.

In one or more implementations, the induction coil is a first induction coil. The first induction coil has a first U-shaped ferrite core. The inductive cooktop also has a second induction coil disposed adjacent the first induction coil. The second induction coil has a second U-shaped ferrite core. The first and second induction coils may be operated with opposite current polarity. In one or more implementations, the driver is a first driver, and the first induction coil is driven with the first driver of a first polarity. The second induction coil is driven with a second driver of a second polarity, where the second polarity is opposite the first polarity.

In one or more implementations, the inductive cooktop includes a third induction coil and a fourth induction coil. The third induction coil has a third ferrite core and the fourth induction coil has a fourth ferrite core. The first, second, third and fourth induction coils may be disposed in a two by two array. The third and fourth induction coils are operated with opposite current polarity. The first and third induction coils may be operated with opposite current polarity, so that each coil is operated with opposite current polarity relative to each adjacent coil in the two by two array. In one or more implementations, the first induction coil is driven with the first driver of a first polarity. The second induction coil is driven with a second driver of a second polarity where the second polarity is opposite the first polarity. The third induction is driven with a third driver of the second polarity and the fourth induction is driven with a fourth driver of the first polarity.

In one or more implementations, the driver is a first driver, and the first and second induction coils are connected in series with opposite polarity and in series with the first driver. The third and fourth induction coils may be connected in series with opposite polarity and in series with a second driver. The first induction coil and the third induction coils maybe arranged with opposite polarity relative to the first and second drivers respectively.

In another aspect, an inductive cooktop includes a transparent panel configured to support a cookware object. The inductive cooktop includes an electrically actuated display panel disposed below the transparent panel. The electrically actuated display panel has a first set of lines and a second set of lines disposed orthogonal to each other to form a two dimensional matrix that is configured to operate pixels disposed at intersections of the first set and second set of lines where each pixel is repeatedly refreshed at a refresh rate. The inductive cooktop includes an induction coil array disposed below the electrically actuated display panel. The induction coil array is operable to generate a time varying electromagnetic field that inductively couples with the cookware object supported at the transparent panel. The inductive cooktop includes a driver array in electronic communication with the induction coil array. The driver array includes a power source for providing power to the induction coil array to generate the time varying electromagnetic field. The refresh rate of the pixels is synchronized to the time varying electromagnetic field to minimize an induced voltage on one of the first and second set of lines.

In one or more implementations, the induction coil array comprises a plurality of induction coils disposed in a rectangular array. In one or more implementations, the induction coil array comprises a first, second, third, fourth, fifth, and sixth induction coils arranged in a two row by three column array. In one or more implementations, a first current magnitude in a first and third column of the array is less than a second current magnitude in a second, central column of the array.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of an example countertop with an inductive cooktop.

FIG. 2 is a perspective view of an example disc-shaped induction coil disposed below a pan resting on an inductive cooktop.

FIG. 3 is a schematic view of an example magnetic field generated by the induction coil generated by the induction coil shown in FIG. 2.

FIG. 4 is a schematic view of an example magnetic field generated by a U-shaped induction coil.

FIG. 5 is a schematic view of an example stack of layers corresponding to the inductive cooktop of FIG. 1.

FIG. 6 is a top plan view of an example arrangement of induction coils for the inductive cooktop of FIG. 1.

FIG. 6A is an enlarged plan view of the induction coils at section A/B shown in FIG. 6.

FIG. 6B is an enlarged plan view of the induction coils at section 1/B shown in FIG. 6 schematically illustrating the electromagnetic field lines aligned with the data lines of the display panel.

FIG. 7 is a perspective view of the induction coil array of FIG. 6A and FIG. 6B illustrating the electromagnetic field lines.

FIG. 8 is a schematic plan view of a representative inductive coil relative to data and scan lines of a display panel.

FIG. 9 is a schematic plan view of the representative inductive coil of FIG. 8 further illustrating electromagnetic field lines.

FIG. 10 is a graph depicting a normalized waveform of an alternating current power input and a normalized voltage waveform of an induction coil in use to transfer energy to the cooktop object.

FIG. 11 is a schematic plan view of a representative inductive coil misaligned relative to data and scan lines of a display panel.

FIG. 12 is a schematic plan view of an alternative representative inductive coil misaligned relative to data and scan lines of a display panel.

FIG. 13 is a schematic plan view of a pair of representative inductive coils relative to data and scan lines of a display panel further illustrating electromagnetic field lines.

FIG. 14 is a schematic plan view of a four-coil array of representative inductive coils relative to data and scan lines of a display panel indicating opposing current flow directions.

FIG. 15 is a circuit diagram illustrating a first power distribution scheme of a four coil array as in FIG. 14.

FIG. 16 is a circuit diagram illustrating a second power distribution scheme of a four coil array as in FIG. 14.

FIG. 17 is a schematic plan view of a six coil array of representative inductive coils relative to data and scan lines of a display panel indicating opposing current flow directions.

FIG. 18 is a schematic view of an example computing device that may be used to implement the systems and methods described herein.

Like reference symbols in the various drawings indicate like elements.

### DETAILED DESCRIPTION

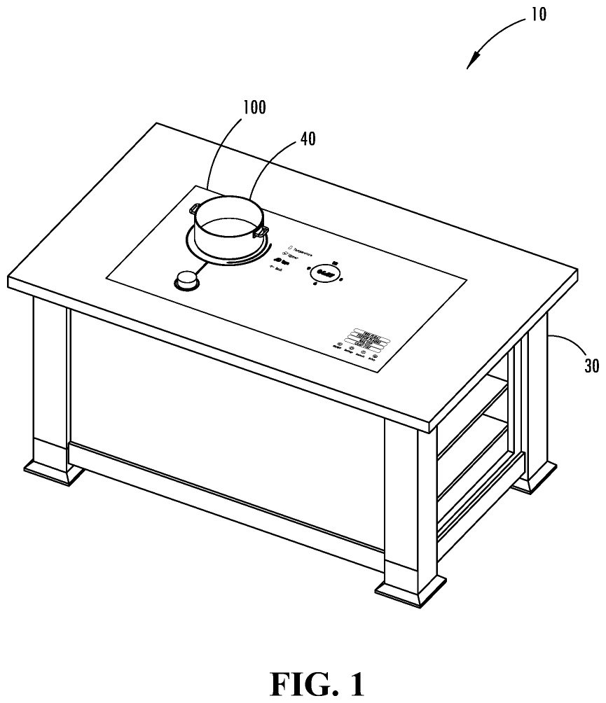

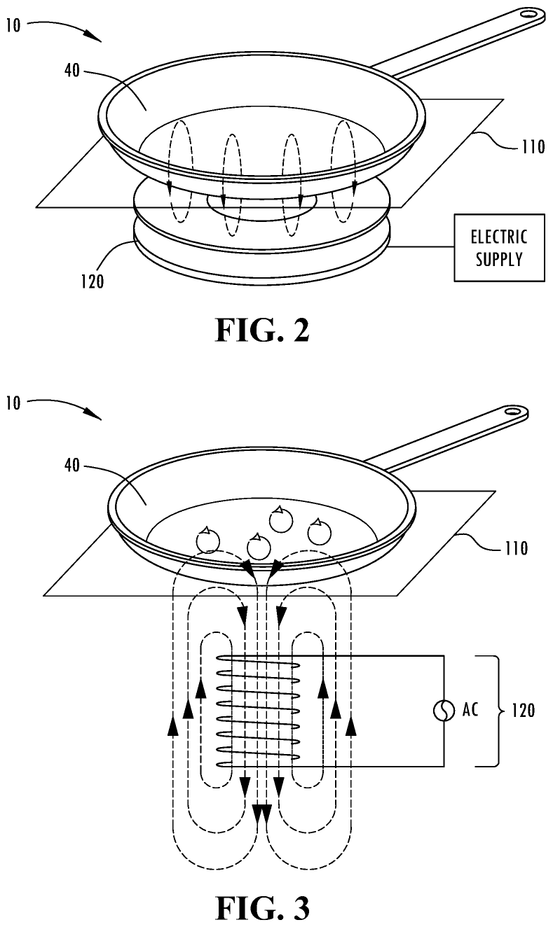

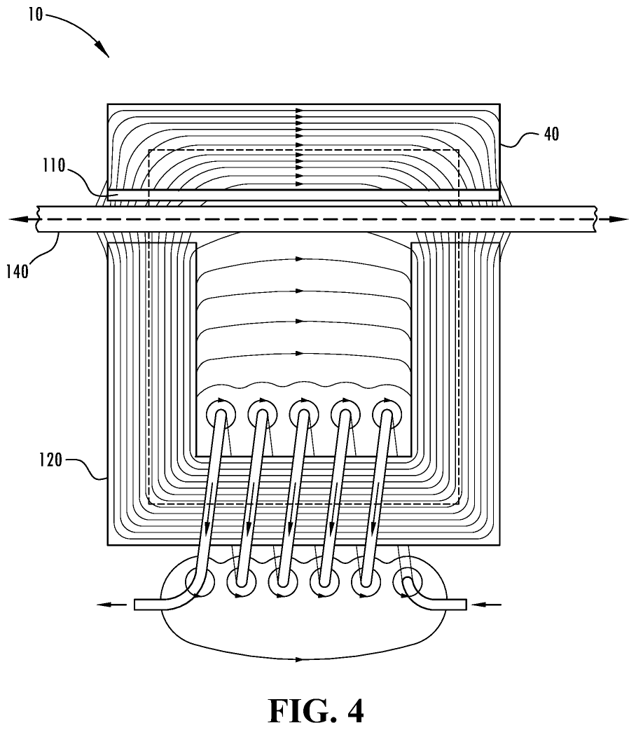

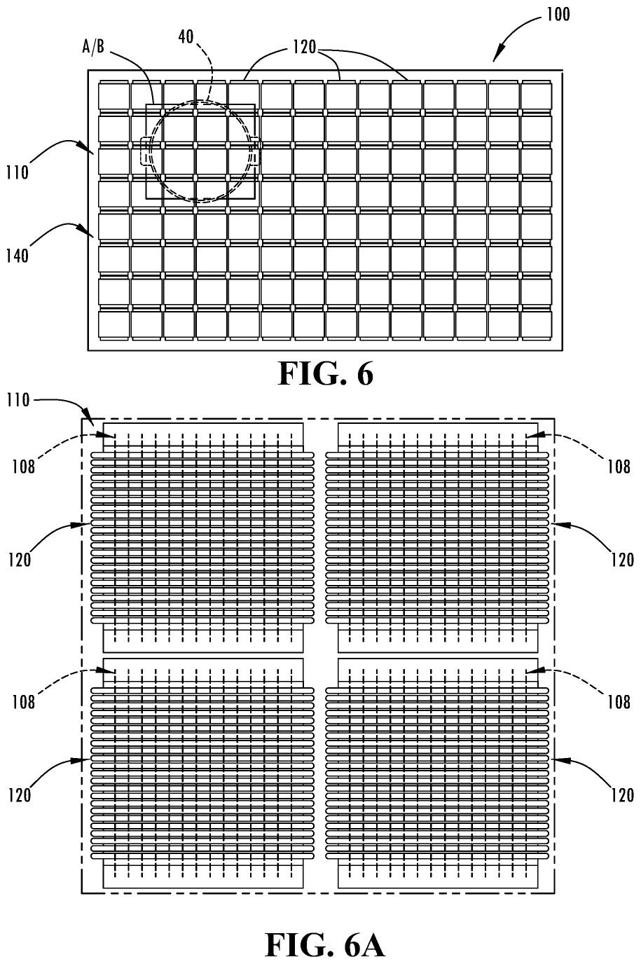

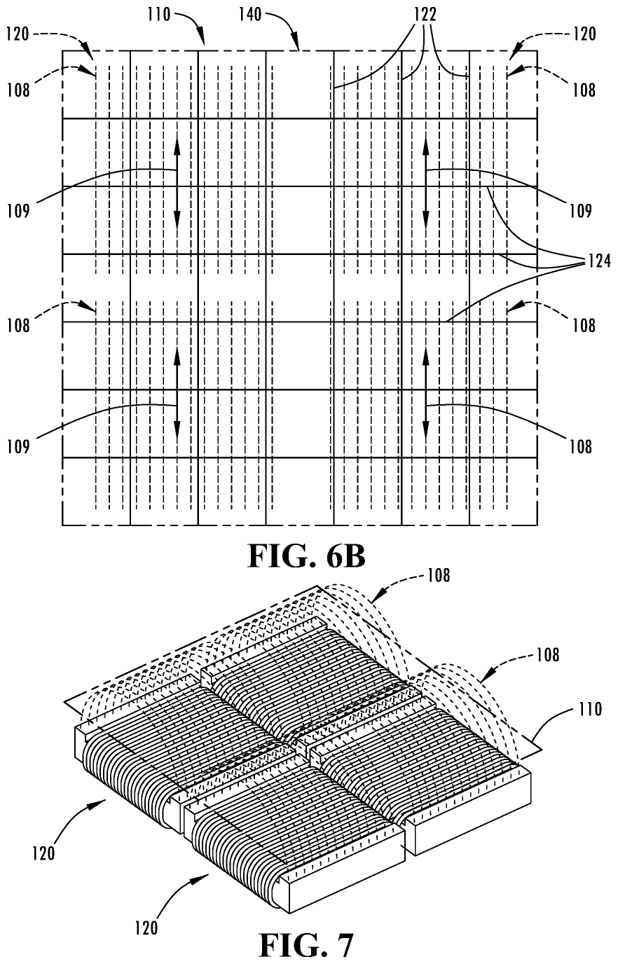

Referring to FIG. 1, an inductive cooktop 100 is provided in a kitchen environment 10 or other area used to prepare and cook food. For example, FIG. 1 illustrates the inductive cooktop system 100 installed in a countertop 20 of a cabinet 30 within the kitchen environment (e.g., a kitchen island). As shown in FIGS. 2 and 3, the inductive cooktop system 100 includes a top plate 110 (e.g., a transparent glass and/or ceramic panel) and an induction coil 120 (e.g., a solenoid coil) that is disposed below the top plate 110. Here, the induction coil 120 may refer to a solenoid coil of various shapes or configurations ranging from a C-shaped coil where each end of the “C” is adjacent to the top plate 110 (e.g., as shown in FIG. 4) to a more traditional pancake coil. The induction coil 120 may refer to a single coil or a plurality of coils (e.g., shown as an array of coils in FIGS. 6-9) below the top plate 110.

A power supply may supply alternating current, such as high-frequency or medium frequency current to the induction coil 120 to create a time varying electromagnetic (EM) field that can inductively couple with and heat a cookware object 40 e.g., a pan) supported on an upper surface of the top plate 110. The EM field may permeate through the upper surface of the top plate 110 in the area immediately above the induction coil 120, such as shown in FIGS. 2, 3, and 4. The EM field oscillates to create eddy currents in or near the bottom portion of the cookware object 40 that is supported on the top plate 110, such that the resistance of the cookware object 40 to the eddy currents causes resistive heating of the cookware object 40. Thus, the inductively heated cookware object 40 may heat and cook the contents within the cookware object 40. To adjust cooking settings, such as temperature, the power (e.g., via the current) supplied to the induction coil 120 may be adjusted.

The cookware object 40 may include a ferrous metal, such as at least at a base of the cookware object 40, to be capable of inductively coupling with the induction coil 120 and conductively spreading the heat to the cooking surface within the cookware object 40. The cookware object 40 may include various types of cooking vessels, such as a pot, a pan, an induction plate, a wok, and the like. It is also contemplated that the cookware object 40 may be product packaging, such as a metal food packaging that is configured to be used without an underlying piece of cookware. Further, it is contemplated that the other non-cookware objects may be used in place of the cookware object 40, such as an electrical or electronic device that is configured to inductively couple with the induction coil 120 to transfer data or power via the inductive coupling. Such an electrical device may include a kitchen appliance, such as a toaster or blender, a receptacle unit for plugging in other devices via electrical wires, or other personal electronic devices, such as cell phones. It should be understood that references herein to cookware object 40 includes non-cookware objects susceptible inductive coupling with the induction coil 120.

In some configurations, the system 100 includes a display element (e.g., shown as display panel 140), the configuration and/or construction of the coils 120 may aid in mitigating the coupling effects of the alternating EM field generated by the coil 120. In some examples, such as FIG. 4, the coil 120 is constructed as a U-core solenoid coil magnet to align the EM field line or flux in a given direction. Also, the induction coils in FIG. 6 include an arrangement of U-core induction coils 120 that are each positioned to align the EM fields in a common direction. By orienting the U-core solenoid coil magnet with a display element (e.g., display panel 140), metal or conductive lines in the display (e.g., the backplane of the display), which may be most vulnerable to electrical interference, are aligned parallel or generally parallel to the EM field lines. Additionally or alternatively, metal or conductive lines in the display that are identified as less vulnerable or least vulnerable to electrical interference may be aligned orthogonal to the EM field lines.

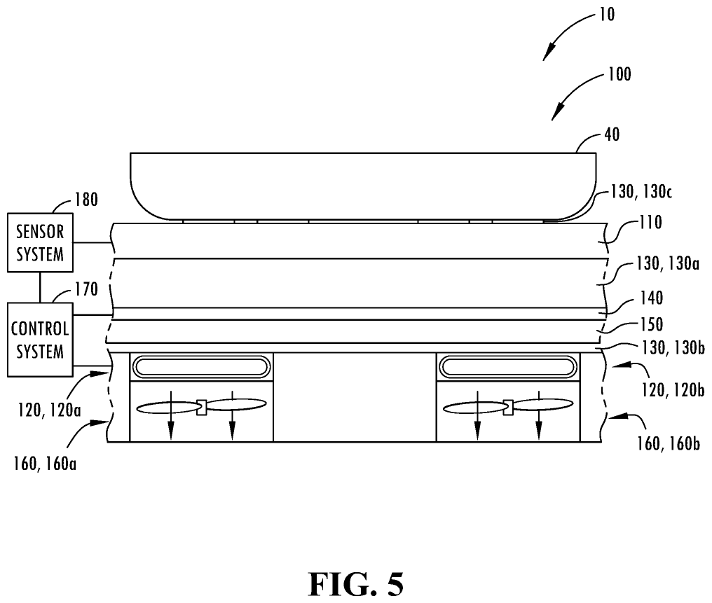

Referring to FIG. 5, the inductive cooktop system 100 may include one or more dissipation layers 130 and a display panel 140 between the cook top surface 110 and the induction coil 120 (also referred to as a coil layer 120). Here, a dissipation layer 130 may act as a thermal insulator such that heat generated by the coil layer 120, the display panel 140, and/or the cooktop surface 110 (e.g., via the cookware object 40) may be dissipated during operation of the cooktop system 100. This dissipation may help prevent malfunction and/or failure of different layers of the system 100, such as the display panel layer 140. A dissipation layer 130 may be a thermal insulating material or an air gap that allows air to flow between the layers. Here, in FIG. 5, the system 100 includes a first dissipation layer 130a between the cooktop surface 100 and the display panel 140, a second dissipation layer 130b between the display panel 140 and the coil layer 120, and a third dissipation layer 130c between the cookware object 40 and the cooktop surface 110. Although the system 100 illustrates three dissipation layers 130, 130a-c, the system 100 may include any number of dissipation layers 130. In some examples, in order to maintain the position of each layer, one or more layers of the system 100 may have structural standoffs. Additionally or alternatively, the system 100 or portions thereof may be fixed in position by a frame structure corresponding to the system 100.

Beneath the display panel 140, a support layer 150 (e.g., a glass support layer) provides a non-conducting support for the display panel 140. Below the support layer 150, a second dissipation layer 130b is shown separating the display panel 140 from the coil layer 120 (e.g., shown as two coils, 120, 120a-b). Beneath the coil layer 120, the system 100 may additionally include a cooling layer 160. For instance, each coil 120a-b includes a downdraft fan 160, 160a-b that functions to draw heat downward and away from the layers above the coil layer 120 (e.g., the display 140 or the cooktop surface 110). Additional or alternative cooling systems, such as heat sinks or liquid cooling, may be employed in additional examples to draw heat away from the coils.

The display panel 140 generally operates by coordinating the emission of light to generate graphics or other content information. For instance, based on this operation, a user perceives the emission of light as a display projected on the cooktop surface 110. Here, the display panel 140 is an organic light emitting diode (OLED) display panel that emits light using one or more OLEDs. In additional examples, the display panel may be a thin-film-transistor liquid crystal display (TFT LCD) panel, a light-emitting diode display (LED) panel, a plasma display panel (PDP) a liquid-crystal display (LCD) panel, a plasma display panel (PDP), or an electroluminescent display (ELD) panel. However, to use an OLED display panel 140 in conjunction with an induction coil layer 120, the system 100 needs to ensure that the OLED display panel 140 functions in particular operating conditions. For instance, the operation of the OLED display panel 140 may be diminished or compromised if the OLED display panel 140 is subjected to too much heat or too much electrical interference from a EM field associated with the coil layer 120.

In some examples, the inductive cooktop 100 includes a control system 170, such as control system circuitry, that is configured to detect or to receive inputs from a sensor system 180 and to perform processing tasks related to those inputs. In some configurations, the control system 170 is coupled to or in communication with the coil layer 120, the display 140, and/or the sensor system 180. For instance, the control system 170 may be physically wired to interfaces of these elements or communicate wirelessly with these elements. With respect to the display panel 140, the control system 170 is configured to control the display panel 140, such as to display information at the cooktop surface 110, including at an area or areas of the upper surface that interfaces with a cookware object 40 that is inductively coupled with an induction coil 120. The control system 170 may control information displayed by the display panel 140 before, during, or after operation of the induction coil 120 inductively coupling with a cookware object 40. Some examples of information displayed by the display panel 140 include operational information of the cooktop, outlines of cooking zones or control interfaces, control interface images, media widows or information, or branding or advertising windows or information and other conceivable images and graphics. In some implementations, to control the display 140, the control system 170 is configured to control individual pixels of the display 140 by interfacing with and controlling voltage, current, and/or other signals to a pixel circuit.

In addition to controlling the display 140, the control system 170 is configured to control the coil layer 120. Here, the control system 170 may supply power (e.g., in the form of voltage or current) to one or more coils 120 of the coil layer 120 to activate, deactivate, or adjust the characteristics of the coil 120 (e.g., adjust the heating power of one or more coils 120). In some configurations, the control system 170 includes more than one controller. Here, each controller may operate individually or communicate with each other to control some portion of the system 100. For instance, each of the display 140, the coil layer 120, and/or the sensor system 180 may include its own controller(s) that collectively form the control system 170. For example, different types of controllers may be used throughout the system 100 depending on the communication protocols required or the type of information/data that is being communicated.

FIG. 6 is an example of the inductive cooktop system 100 where the display panel 140 is transparent to illustrate the system 100. Here, a top surface of each coil 120 of the array of induction coils 120 is depicted generally within the same plane. Yet this does not have to be the case. For example, different coils 120 within the array may be at different distances from the cooktop surface 110 (e.g., a bottom surface of the cooktop surface 110). In other words, each coil 120 may be set at a particular distance to the cooktop surface 110 independent of other coils 120 within the array. In some implementations, the coils 120 are arranged in a pattern based on their distance from their top surface of the coil 120 facing the cooktop surface 100 to the cooktop surface itself. In some configurations, the coils 120 within the array are configured such that each coil 120 has some degree of adjustability in the x, y, and/or z-direction. Here, the z-direction corresponds to moving upwards or downwards with respect to the cooktop surface 110 while the x-direction corresponds to moving left or right and the y-direction corresponds to moving towards the foreground or the background.

In some examples, the coils 120 are held in a coil holder (e.g., a frame or container that supports the coils 120) where the coil holder is adjustable with respect to the cooktop surface 110 (e.g., adjustable upwards towards the cooktop surface 110 or downwards away from the cooktop surface 110). Additionally or alternatively, the system 100 may be constructed such that the display 140 is adjustable with respect to the coil layer 120. For instance, the coil layer 120 is fixed while the display 140 moves upward or downward. In other examples, both the display 140 and the coil layer 120 have some degree of adjustability within the system 100.

FIGS. 6A, 6B are an example of some of the induction coils 120 disposed below the cookware object 40 in FIG. 6. As shown in FIG. 6B, the display panel 140 includes two sets of lines 122, 124 that are disposed orthogonal to each other to form a two-dimensional matrix that is configured to operate associated lighting elements with an addressing scheme. One set of lines are data lines 122 (i.e., high impedance lines) and the other set of lines are scan lines 124 (i.e., low impedance lines). The data lines 122 shown in FIG. 6A, when viewed in the Z-direction from above, are disposed vertically or longitudinally (i.e., in a column) on the display panel 140 and the scan lines 124 are disposed horizontally or laterally (i.e., in a row) on the display panel 140. This is not intended to be limiting and the orientation of the data lines 122 and scan lines 124 may be reversed. The electrically actuated panel may be various types of illumination panels or other types of panels in other implementations of the inductive coils described herein. The induction coils 120 disposed below the display panel 140 are operable to generate an EM field 108 that inductively couples with the cookware object 40 supported at the transparent top plate. To avoid interference or damage to the data lines 122, induction coils 120 may emit an EM field 108 that is largely parallel to the data lines 122, and thus will minimize any induced voltage or current on the data lines 122. As shown in FIG. 7, the induction coils 120 are operable to generate the EM fields 108 with a flux direction 109 in general parallel alignment with the data lines 122 to generally prevent the EM fields 108 from inducing a voltage on the data lines 122.

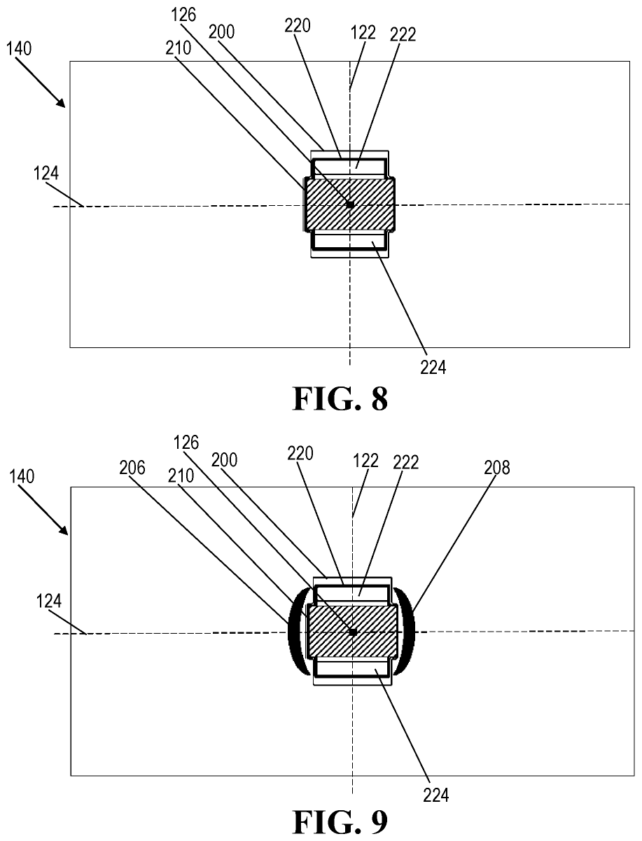

FIG. 8 shows a representative induction power coil 200 underneath a section of the display panel 140. This coil 200 uses horizontal windings 210 wrapped around a ferrite core structure 220 in the shape of a “U” with a central horizontal portion defining a longitudinal axis and vertical members 222 and 224 extending upwards towards the display panel 140. The conductive wire of the induction power coil 200 is wrapped or coiled around the horizontal portion of the ferrite core. The vertical members 222, 224 direct the EM flux through the display towards the cookware object 40. As described above the display panel 140 is made up of a matrix of data lines 122 and scan lines 124 respectively—wherein the display panel 140 includes a matrix of picture elements, or pixels 126, are individually addressed in a raster with the data lines 122 providing color and intensity data at each pixel 126 and the scan lines 124 writing the data from the data lines 122 to the pixel 126. This is typically done in a raster form wherein the scan lines 124 are individually updated from top to bottom in sequence with the data from each data line 122 is written simultaneously across the scan line 124. FIG. 8 is illustrated with a single representative power coil 200, and a single data line 122, and single clock line 124 to simplify the illustration and accompanying discussion, but is should be understood that the display panel 140 may comprise a matrix of pixels, resulting in an image resolution, for example of 100 pixels by 100 pixels, 1280 pixels by 1024 pixels, 1920 pixels x. 1080 pixels, or other suitable resolution depending on the individual pixel size and the desired dimensions of the display panel 140. Similarly, the number of data lines 122 and scan lines 124 will vary with the number of pixels comprising the display panel 140.

FIG. 9 shows the representative induction power coil 200 with an EM field being generated, represented by lines of EM flux 206, 208 traveling from vertical members 222 and 224. In this scenario, the EM flux may induce voltage on the data and clock lines as it is an AC EM field traveling through a matrix of conductors. The data lines 122 have voltage induced in one direction near vertical member 222 as the flux is extending vertically through the display panel 140 upwards, however the inducted voltage near vertical member 224 is equal with an opposite polarity as it is traveling downwards through the display panel 140. This results in a near zero net voltage across the data line 122. Scan line 124 experiences induced voltage as the flux lines 206, 208 are passing over the scan line 124 in one direction. This induced voltage can create issues in the displayed image, causing incorrect data to be written to the pixel locations controlled by scan line 124.

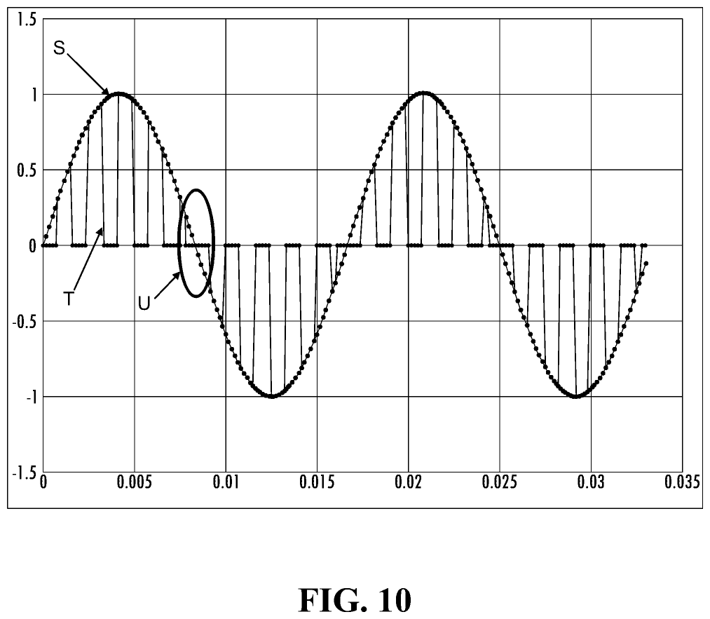

FIG. 10 shows a graph of the normalized change in current over two operational cycles in the representative induction coil 200 in a system 100 powered by an AC voltage source or driver, in electronic communication with the induction coil 200. The graphic illustrates a voltage waveform S as the 60 Hz AC line power, and a voltage waveform T is the higher frequency waveform used to transfer energy to the cooktop object 40 by applying a square wave envelope to the AC power input. Region U is near the zero-cross point of the AC waveform S. By synchronizing the AC waveform S with the display panel 140 refresh cycle, the scan lines 124 near the region of the coil 200 can be “clocked in” when the AC waveform is near the region U, reducing or even eliminating the induced voltage issues occurring on the scan line 124 and allowing the display panel 140 to continue to function normally. Alternatively, if the signal on the scan line 124 cannot be synchronized with the AC waveform S, the square wave T may be turned off for a brief period of time as the scan line 124 is being updated over the representative coil 200 in the proximity of the cookware object 40. This method may significantly lower the total delivered power as the timing may occur at or near the peak of the AC waveform S, which is the period at which power delivery is highest. Alternatively, if the system 100 is powered by a DC energy source, the applied square wave T between a power-on state and a power-off state, may be turned off as the scan lines 124 over the coil 200 are being updated, reducing the power delivered as a function of the duty cycle of the “off” period. Power may be increased during the remaining “on” periods by adjusting the coil frequency, input voltage, or any other power adjustment means known in the art of induction power transfer.

In addition to time-synchronizing the coil power with display scan line updates, the display panel 140 or the coil array 120 may operate at a frequency that is substantially different than the fundamental frequency and resolution of the display panel 140. For example, in a display with a pixel resolution of 1920×1080 and a 60 Hz refresh rate, each display data line 122 is written to at a frequency of 60*1080=64.8 kHz. If the coils 120 operate at the same frequency, any induced noise on the display panel 120 may appear as a standing wave with some data lines 122 experiencing much higher intensity of noise due to the time variation of the EM field wherein a peak EM field may occur as data is being written to each pixel, maximizing the induced noise. By operating the time varying EM field at a frequency of between about ⅔ to about ½ of the display panel's 140 refresh frequency, the average induced voltage on each scan line 124 is reduced by varying in time the amount of coupled noise. The frequency of the coil EM field may be ⅔ of the display panel's 140 refresh frequency. The frequency of the coil EM field may be ½ of the display panel's 140 refresh frequency. Alternatively, the coils 120 may operate at the same frequency as the display panel 140 wherein the coils 120 are driven to ensure that when the coil current crosses the 0-point, data is written to the pixel located at the respective coil location. Because the coils 120 are typically voltage controlled, adjusting the 0-cross of current may require the drivers to be current controlled instead of voltage controlled.

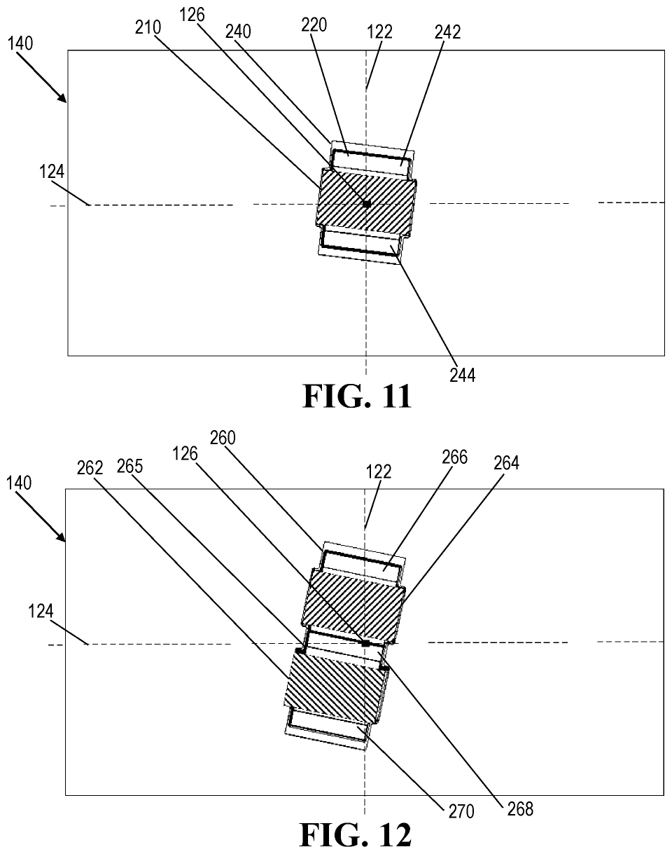

FIG. 11 shows an example of a representative U-shaped coil assembly 240, similar to coil 200, but with poor alignment to the display panel 140. Poor alignment occurs when the longitudinal axis of the central portion of the ferrite core is not parallel to the data lines 122 and orthogonal to the scan lines 124. The degree of misalignment may be when the ferrite core 220 is angled at between about 1° to about 45°, between about 5° to about 45°, or between 5° to 15° relative to the data lines 122. In this scenario, there is an uneven flux distribution across the vertical ferrite elements 242 and 244 mean that a display data line 124 passes through an EM field that has a non-zero net flux passing through the vertical axis of the data line 124, inducing a voltage. This induced voltage can disrupt the data passed to the pixel locations along the length of the data line 124. Synchronizing the coil power with the display scan line 124 updates can help minimize the induced voltage and avoid the disruption of the data by the coil power.

FIG. 12 shows an alternative E-shaped coil assembly 260 wherein the coil 260 is not aligned with the data and scan lines 122, 124 of the display panel 140. Symmetric coil windings 262, 264 are wound in opposite direction along the central portion of the central ferrite 265, the central portion defining and extending along a longitudinal axis, with two end vertical ferrite members 266, 270 and a central vertical ferrite member 268. In this coil assembly 260, the EM flux coming out of the central vertical ferrite member 268 upward is roughly twice the amplitude of the EM flux going down into the end vertical ferrite members 266 and 270. The magnetic flux is typically distributed along the axis of the vertical members 266, 268, 270, wherein the flux density is higher in the middle and lower toward the edges. The total resulting magnetic flux along the axis of the data line 122 is nearly zero. The downward flux at the intersection of the data line 122 with the end vertical members 266, 270 is roughly equal in magnitude but in the opposite direction as the flux where the data line 122 crosses the vertical member 268, resulting in zero next flux and minimal induced voltage along the axis of the ferrite element. Utilizing E-shape coil assemblies 260 in the coil array 120 allows the overall design of the system 100 to be less sensitive to the alignment of the coils comprising the coil array 120 to the display panel's data lines 122.

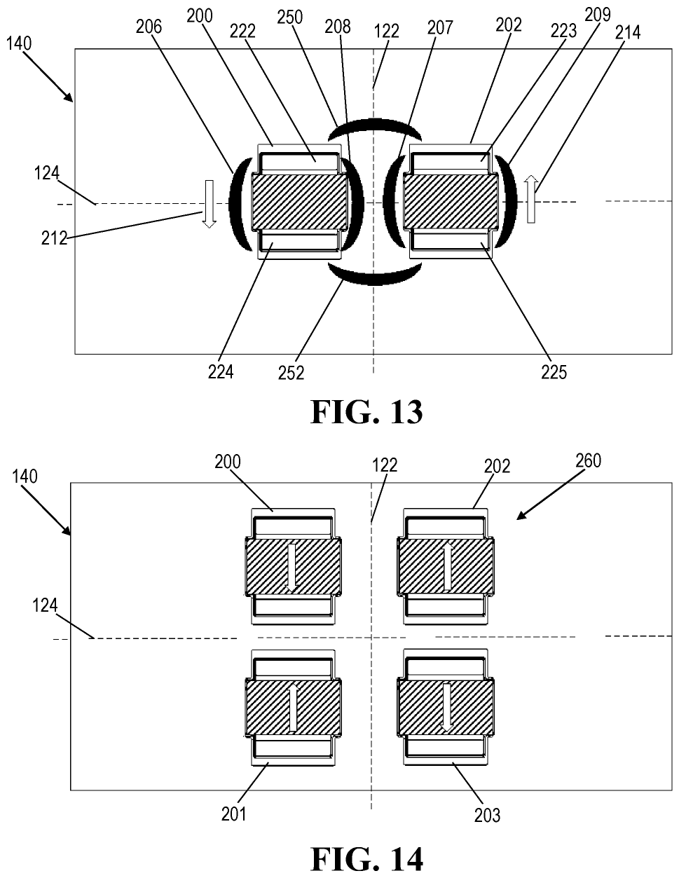

FIG. 13 shown a representative example of two similar U-shaped coil assemblies 200, 202, wherein the coils are identical but have currents 212, 214 flowing in opposite directions. The lines of EM flux 206, 208 and 207, 209 form between the vertical elements 222, 224 and 223, 225 of each individual coil, and due to the opposing poles formed by opposite currents 212, 214 form lateral lines of flux 250, 252. Using two adjacent coils 200, 202 with opposing currents 212, 214, the lines of flux 206, 208 and 207, 209 that form above each coil 200, 202 induce voltage on the display panel 140 scan lines 124, but because the lines of flux 206, 208 and 207, 209 are in opposite directions, the induced voltage is near zero on the scan line 124. If the current flowing in the two coils 200, 202 are equal but flow in opposite direction, and the coils 200, 202 are otherwise identical in construction, then the net induced voltage on display scan lines 124 will be zero.

FIG. 14 shows a representative example of four similar U-shaped coil assemblies 200, 201, 202, 203 wherein each coil is constructed identically, and have currents flowing in opposite polarity as the adjacent coils. Using arrays of four coil subsets 260, a flexible cooktop system 100 may be configured by selecting various numbers of coils to increase or decrease the active area or delivered power. Using coils of opposite polarities in the vertical columns, i.e., coils 200, 201, the lines of flux created within a row of coils has a reduced impact on the flux created within an adjacent row since the opposing pole configuration at any given point in time creates opposing forces.

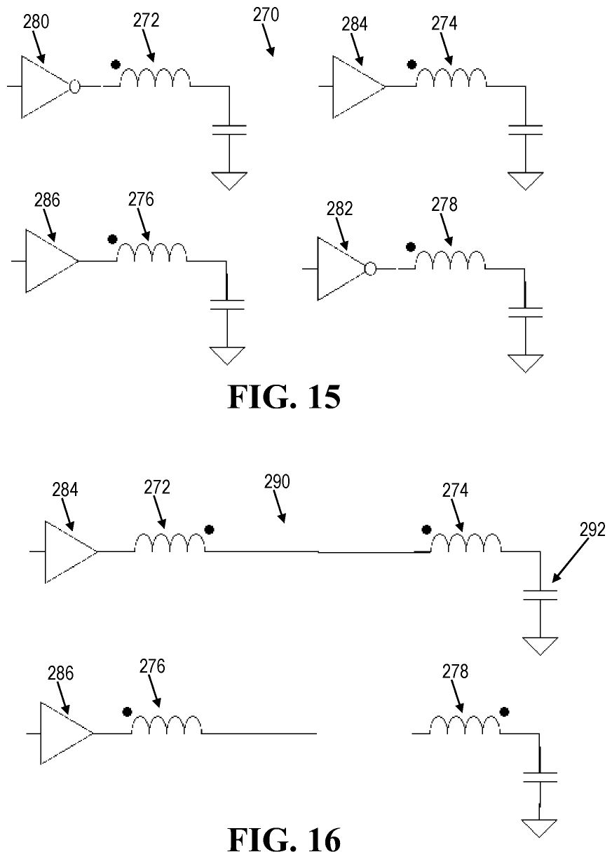

FIG. 15 shows an example of a driver configuration 270 for a four coil array, wherein each coil 272, 274, 276, 278 is wound identically with the same polarity, but are driven with two drivers 280, 282 of a first polarity and two drivers 284, 286 of an opposite polarity. These drivers 280, 282, 284, 286 may be a half bridge metal-oxide-semiconductor field-effect transistor (MOSFET) driver, insulated-gate bipolar transistor (IGBT), or any other driver known in the art.

FIG. 16 shows another example of a driver configuration 290 for a four coil array, wherein the two coils 272, 274 and 276, 278 within a row are wound in opposing directions and connected in series. Alternatively, the coils 272, 274 and 276, 278 may be wound identically but connected in series so that the negative terminal of one coil 272 is connected to the negative terminal of the adjacent coil 274 or so that the positive terminal of one coil 276 is connected to the positive terminal of the adjacent coil 278. In this configuration, the coils 272, 274 and 276, 278 connected in series operate so that the current flowing through the adjacent coils is equal in magnitude. The arrangement 290 shown in FIG. 16 create a more even EM field that results in less induced voltage in the display data and scan lines 122, 124. This array may also be driven with a single driver, with the series connections of two coils being connected in parallel, instead of two independent drivers, lowering the cost of the system. In addition, all four coils may by connected in series with a single resonant capacitor 292 to create a single resonant network, ensuring an even current distribution within the entire array. Alternatively, when coils are wound around an E-core ferrite 265, as shown in FIG. 12, the windings may be done in opposing directions forming a configuration similar to coils 272 and 274, wherein the coils are wound around the same axis and then connected in series.

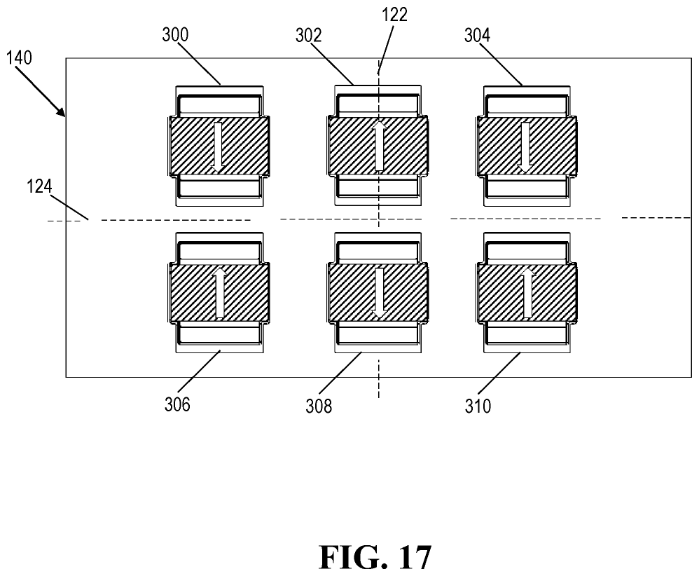

FIG. 17 shows FIG. 11 shows a six coil array wherein each coil 300, 302, 304, 306, 308, 310 is identical to one another and is driven in a configuration that creates currents in opposite directions as the adjacent coils. In this embodiment, an odd number of coils within a row—such as 300, 302, and 304—produce an uneven amount of flux seen by display scan lines 124 above and proximate to the row. This causes an induced voltage which may impact the displayed image. To counter this, a current magnitude in the middle coil 302, 308 of a row may be increased relative to a current magnitude in the outer coils 300, 304, 306, 310 to reduce the net flux seen by the horizontal display scan lines 124.

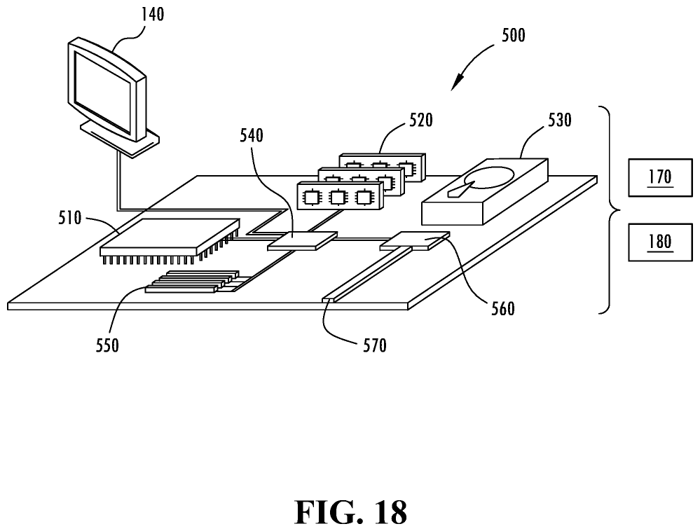

FIG. 18 is schematic view of an example computing device 500 that may be used to implement the systems (e.g., systems 100) and methods described in this document. The computing device 500 is intended to represent various forms of digital computers/processors, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 (e.g., data processing hardware), memory 520 (e.g., memory hardware), a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common circuit board, such as a motherboard, or in other manners as appropriate. The processor 510 can process instructions for execution within the computing device 500, including instructions stored in the memory 520 or on the storage device 530 to display graphical information for a graphical user interface (GUI) on an external input/output device, such as display 140 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASIC s (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device (e.g., the display 140) or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An inductive cooktop comprising:
a transparent panel configured to support a cookware object;
an electrically actuated display panel disposed below the transparent panel, the electrically actuated display panel comprising a first set of lines and a second set of lines disposed orthogonal to each other to form a two dimensional matrix that is configured to operate pixels disposed at intersections of the first set and second set of lines, each pixel being repeatedly refreshed at a refresh rate; and
an induction coil disposed below the electrically actuated display panel, the induction coil operable to generate a time varying electromagnetic field that inductively couples with the cookware object supported at the transparent panel; and
a driver in electronic communication with the induction coil, the driver comprising a power source for providing power to the induction coil to generate the time varying electromagnetic field;
wherein the refresh rate is synchronized to the time varying electromagnetic field to minimize an induced voltage on one of the first and second set of lines.

2. The inductive cooktop of claim 1, wherein the power source is an alternating current (AC) voltage source generating an AC waveform, and wherein the refresh rate is synchronized to the time varying electromagnetic field to refresh at a zero-cross point of the AC waveform.

3. The inductive cooktop of claim 1, wherein the power source is a direct current (DC) power source generating a square waveform between a power-on and a power-off state, and wherein the refresh rate is synchronized to refresh at a power-off state of the time varying electromagnetic field.

4. The inductive cooktop of claim 1, wherein the time varying electromagnetic field operates at a field frequency between ⅔ and ½ of a refresh frequency of the refresh rate.

5. The inductive cooktop of claim 1, wherein the time varying electromagnetic field operates at a field frequency equal to the refresh rate, and wherein the refresh occurs synchronized to a zero-cross point of the time varying electromagnetic field generated by the induction coil.

6. The inductive cooktop of claim 1, wherein the induction coil comprises a conductive wire wound around a ferrite core, the ferrite core defining a longitudinal axis; and wherein the longitudinal axis is parallel to one of the first set of lines or the second set of lines of the display panel.

7. The inductive cooktop of claim 1, wherein the induction coil comprises a conductive wire wound around a ferrite core, the ferrite core defining a longitudinal axis; and wherein the longitudinal axis is angled with respect to one of the first set of line or the second set of lines of the display panel between 1° to 45°.

8. The inductive cooktop of claim 1, wherein the induction coil comprises a conductive wire wound around a ferrite core, the ferrite core comprising a horizontal central portion extending between vertical members, the conductive wire being wound around the central portion between the vertical members.

9. The inductive cooktop of claim 8, wherein the ferrite core comprises a first end vertical ferrite member, a second end vertical ferrite member opposite the first end vertical ferrite member along the central portion, and a third central vertical ferrite member between the first and second end vertical ferrite members.

10. The inductive cooktop of claim 1, wherein the induction coil is a first induction coil, the first induction coil comprising a first U-shaped ferrite core; the inductive cooktop further comprising a second induction coil disposed adjacent the first induction coil, the second induction coil comprising a second U-shaped ferrite core; and wherein the first and second induction coils are operated with opposite current polarity.

11. The inductive cooktop of claim 10, wherein the driver is a first driver, and wherein the first induction coil is driven with the first driver of a first polarity, the second induction coil is driven with a second driver of a second polarity, the second polarity being opposite the first polarity.

12. The inductive cooktop of claim 10, further comprising a third induction coil and a fourth induction coil, the third induction coil comprising a third ferrite core and the fourth induction coil comprising a fourth ferrite core; the first, second, third and fourth induction coils being disposed in a two by two array, and the third and fourth induction coils are operated with opposite current polarity; and wherein the first and third induction coils operated with opposite current polarity, such that each coil is operated with opposite current polarity relative to each adjacent coil.

13. The inductive cooktop of claim 12, wherein the driver is a first driver; and wherein the first induction coil is driven with the first driver of a first polarity; the second induction coil is driven with a second driver of a second polarity, the second polarity being opposite the first polarity; the third induction is driven with a third driver of the second polarity; and the fourth induction is driven with a fourth driver of the first polarity.

14. The inductive cooktop of claim 12, wherein the driver is a first driver, and wherein the first and second induction coils are connected in series with opposite polarity and in series with the first driver; and wherein the third and fourth induction coils are connected in series with opposite polarity and in series with a second driver; and wherein the first induction coil and the third induction coil are arranged with opposite polarity relative to the first and second drivers respectively.

15. An inductive cooktop comprising:
a transparent panel configured to support a cookware object;
an electrically actuated display panel disposed below the transparent panel, the electrically actuated display panel comprising a first set of lines and a second set of lines disposed orthogonal to each other to form a two dimensional matrix that is configured to operate pixels disposed at intersections of the first set and second set of lines, each pixel being repeatedly refreshed at a refresh rate; and
an induction coil array disposed below the electrically actuated display panel, the induction coil array operable to generate a time varying electromagnetic field that inductively couples with the cookware object supported at the transparent panel; and
a driver array in electronic communication with the induction coil array, the driver array comprising a power source for providing power to the induction coil array to generate the time varying electromagnetic field;
wherein the refresh rate is synchronized to the time varying electromagnetic field to minimize an induced voltage on one of the first and second set of lines.

16. The inductive cooktop of claim 15, wherein the induction coil array comprises a plurality of induction coils disposed in a rectangular array.

17. The inductive cooktop of claim 16, wherein the induction coil array comprises a first, second, third, fourth, fifth, and sixth induction coils arranged in a two row by three column array.

18. The inductive cooktop of claim 17, wherein a first current magnitude in a first and third column of the coil array is less than a second current magnitude in a second, central column of the coil array.
